(19) United States
(12) Patent Application Publication
(10) Pub. No.: US 2022/0324280 A1
(43) Pub. Date: Oct. 13, 2022

(54) RETRACTABLE WHEEL ASSEMBLY

(71) Applicant: Javad SHEIKH JAFARI, Tehran (IR)

(72) Inventor: Javad SHEIKH JAFARI, Tehran (IR)

(73) Assignee: Javad SHEIKH JAFARI, Tehran (IR)

(21) Appl. No.: 17/850,082

(22) Filed: Jun. 27, 2022

Related U.S. Application Data
(63) Continuation-in-part of application No. PCT/IB2020/057833, filed on Aug. 20, 2020.

(30) Foreign Application Priority Data
Dec. 27, 2019 (IR) 13985014000300887

(51) Int. Cl. B60G 17/00; B60G 9/00

(52) U.S. Cl. CPC B60G 17/00; B60G 9/003; B60G 2500/30

(57) ABSTRACT

A retractable wheel assembly may include a fork that may be pivotally coupled to an object and a wheel that may be rotatably mounted on the fork. The retractable wheel assembly may further include a hollow housing that may be made up of an elongated housing portion pivotally coupled to the fork from a first end of the elongated housing portion and a curved housing portion integrally formed with an opposing second end of the elongated housing portion. The retractable wheel assembly may further include a weight disposed and moveable within the housing.

### CROSS-REFERENCE TO RELATED APPLICATION

This application is a continuation-in-part of International Patent Application PCT/IB2020/057833, filed on Aug. 20, 2020, and entitled “SELF-OPENING AND RETRACTING WHEEL ASSEMBLY,” which claims priority to Iranian Patent Application number IR139850140003008874, filed on Dec. 27, 2019. The disclosures of the foregoing applications are incorporated herein by reference in their entirety.

### TECHNICAL FIELD

The present disclosure generally relates to adjustable wheel mechanisms and particularly to retractable wheel mechanisms. More particularly, the present disclosure relates to a self-opening and self-retracting wheel assembly.

### BACKGROUND

Objects and devices that are used in homes or offices may need to be moved occasionally for redecoration, cleaning, or relocation. Some of these objects and devices may be large or bulky objects, such as furniture, washing machines, stoves, refrigerators, file cabinets, and the like, which are difficult to move manually or without any special equipment.

Some objects and devices, such as refrigerators and furniture are wheeled to address some of the difficulties associated with moving them. Wheels and casters may be mounted under large, bulky, and unwieldly items to allow for an easier movement of such items across a support surface with minimum effort.

However, most of the objects and devices need to be stable or perfectly balanced on the support surfaces when they are not moved or relocated. For example, a washing machine that has rotating components needs to be perfectly balanced and level side-to-side and back-to-back or the washing machine may bounce around. Furthermore, visually visible wheels under some objects, such as furniture may not be aesthetically pleasing.

One way to address the above-mentioned problems with wheeled items is to utilize retractable wheels. Retractable wheels or casters may have two states, namely, an operative state where the wheels serve to allow the item to be easily moved along the support surface and an inoperative state where the wheels are retracted not allowing the item to be moved along the support surface. In their retracted or inoperative state, the wheels or casters are not visible and may further allow for a stable positioning of the item on the support surface.

Conventional approaches to design retractable wheel mechanisms have often resulted in complex caster or wheel mechanisms that are difficult to manufacture and use. Consequently, there remains a need for a simple and easy-to-use retractable wheel mechanism that may allow for both moving an item along a support surface when desired and statically support an item on a support surface.

### SUMMARY

This summary is intended to provide an overview of the subject matter of the present disclosure and is not intended to identify essential elements or key elements of the subject matter, nor is it intended to be used to determine the scope of the claimed implementations. The proper scope of the present disclosure may be ascertained from the claims set forth below in view of the detailed description and the drawings.

According to one or more exemplary embodiments, the present disclosure is directed to a retractable wheel assembly. An exemplary retractable wheel assembly may include a fork and a wheel rotatably mounted on an exemplary fork. An exemplary fork may include two spaced-apart parallel flat plates, a main pivot joint that may be mounted between exemplary spaced-apart parallel flat plates on a first end of an exemplary fork, where an exemplary main pivot joint may be configured to allow an exemplary fork to pivot about a main pivot axis of an exemplary main pivot joint. An exemplary fork may further include a main axle that may be mounted between exemplary two spaced-apart parallel flat plates on an opposite second end of an exemplary fork. An exemplary wheel may be rotatably coupled with an exemplary second end of an exemplary fork by utilizing an exemplary main axle. An exemplary wheel may be rotatable about a first pivot axis of an exemplary main axle. An exemplary wheel may further be pivotable with an exemplary fork about an exemplary main pivot joint. An exemplary first pivot axis may be parallel with an exemplary main pivot axis.

An exemplary retractable wheel assembly may further include a hollow housing. An exemplary hollow housing may include an elongated housing portion, where a first end of an exemplary elongated housing portion may be pivotally coupled to an exemplary fork by utilizing a pin joint. An exemplary pin joint may be positioned between an exemplary main axle and an exemplary main pivot joint along a longitudinal axis of an exemplary fork. An exemplary hollow housing may further include a curved housing portion that may be integrally formed with an opposing second end of an exemplary elongated housing portion. An exemplary curved housing portion may curve about an axis parallel with an exemplary main pivot axis. An exemplary housing may be pivotable about a second pivot axis of an exemplary pin joint. An exemplary second pivot axis may be parallel with an exemplary first pivot axis. An exemplary retractable wheel assembly may further include a weight that may be disposed and moveable within an exemplary hollow housing.

### BRIEF DESCRIPTION OF THE DRAWINGS

The novel features which are believed to be characteristic of the present disclosure, as to its structure, organization, use and method of operation, together with further objectives and advantages thereof, will be better understood from the following drawings in which a presently preferred embodiment of the present disclosure will now be illustrated by way of example. It is expressly understood, however, that the drawings are for illustration and description only and are not intended as a definition of the limits of the present disclosure. Embodiments of the present disclosure will now be described by way of example in association with the accompanying drawings in which:

FIG. 1A illustrates a sectional side-view of a retractable wheel assembly in a retracted position, consistent with one or more exemplary embodiments of the present disclosure;

FIG. 1B illustrates a sectional side-view of a retractable wheel assembly in an extended position, consistent with one or more exemplary embodiments of the present disclosure;

FIG. 2A illustrates a perspective view of a retractable wheel assembly, consistent with one or more exemplary embodiments of the present disclosure;

FIG. 2B illustrates a side-view of a retractable wheel assembly, consistent with one or more exemplary embodiments of the present disclosure;

FIG. 2C illustrates a side-view of a fork of a retractable wheel assembly, consistent with one or more exemplary embodiments of the present disclosure;

FIG. 2D illustrates a side-view of a hollow housing of a retractable wheel assembly, consistent with one or more exemplary embodiments of the present disclosure;

FIG. 2E illustrates an exploded side-view of a hollow housing, consistent with one or more exemplary embodiments of the present disclosure;

FIGS. 3A-3D illustrate stages of extending/retracting a retractable wheel assembly mounted on an object, consistent with one or more exemplary embodiments of the present disclosure;

FIG. 4A illustrates a first scenario which encompasses a sideview of a retractable wheel assembly in a fully retracted position, consistent with one or more exemplary embodiments of the present disclosure;

FIGS. 4B and 4C illustrate a second scenario and a third scenario which encompass side-views of a retractable wheel assembly hanging below a main pivot joint, consistent with one or more exemplary embodiments of the present disclosure;

FIG. 4D illustrates a fourth scenario which encompasses a retractable wheel assembly in a fully opened or extended position over a support surface, consistent with one or more exemplary embodiments of the present disclosure;

FIG. 5A illustrates a sideview of a retractable wheel assembly hanging below and from a main pivot joint, consistent with one or more exemplary embodiments of the present disclosure;

FIGS. 5B-5E illustrate various stages of a retractable wheel assembly being retracted, consistent with one or more exemplary embodiments of the present disclosure;

FIG. 6A illustrates different stages of retracting a retractable wheel assembly, consistent with one or more exemplary embodiments of the present disclosure;

FIG. 6B illustrates different stages of retracting a retractable wheel assembly, consistent with one or more exemplary embodiments of the present disclosure;

FIG. 7 illustrates an exploded perspective view of a hollow housing, consistent with one or more exemplary embodiments of the present disclosure;

FIG. 8A illustrates a hollow housing in various stages of extending a retractable wheel assembly, consistent with one or more exemplary embodiments of the present disclosure; and

FIG. 8B illustrates hollow housing in various stages of retracting a retractable wheel assembly, consistent with one or more exemplary embodiments of the present disclosure.

### DETAILED DESCRIPTION

The novel features which are believed to be characteristic of the present disclosure, as to its structure, organization, use and method of operation, together with further objectives and advantages thereof, will be better understood from the following discussion.

The present disclosure is directed to exemplary embodiments of an exemplary retractable wheel assembly that may be coupled to an object to facilitate displacement of that object. An exemplary retractable wheel assembly may be normally placed under an object in a retracted position and may be opened by lifting the object from the ground and then placing the object back on the ground. An exemplary retractable wheel assembly may freely dangle below an exemplary object when an exemplary object is lifted from the ground and when an exemplary object is placed back on the ground the weight of an exemplary object may urge an exemplary dangling retractable wheel to further pivot to a fully extended position.

An exemplary wheel may be retracted from an open or extended position back to a retracted position by lifting the object again and then placing the object back on the ground. Here, an exemplary retractable wheel assembly may freely dangle below an exemplary object when an exemplary object is lifted from the ground and when an exemplary object is placed back on the ground the weight of an exemplary object may urge an exemplary dangling retractable wheel to be retracted back under the object.

An exemplary retractable wheel assembly may include a wheel that may be rotatably coupled to a fork. An exemplary fork may be pivotally coupled to an object at a first pivot point such that an exemplary wheel assembly may be pivotally rotated with respect to the object between a retracted position and an extended or open position. An exemplary fork may freely pivot about a main pivot axis at an exemplary first pivot joint with respect to an exemplary object. An exemplary retractable wheel assembly may further include a hollow housing that may be pivotally coupled to an exemplary fork at a second pivot joint on an exemplary fork. An exemplary hollow housing may be configured to guide an exemplary weight within an exemplary hollow housing such that an exemplary weight may be positioned at various distances from an exemplary second pivot point responsive to an exemplary retractable wheel moving between an exemplary retracted position and an exemplary extended position.

An exemplary hollow housing and an exemplary weight that may be disposed within an exemplary hollow housing may be configured such that when an exemplary wheel is to be pivoted from a retracted position to an extended position, an exemplary weight may exert an extra torque on an exemplary fork of an exemplary retractable wheel to further facilitate extension of an exemplary retractable wheel from under an exemplary object. An exemplary hollow housing and an exemplary weight may further be configured such that when a retractable wheel assembly is to be retracted from an extended position, weight may move close to a center of mass of an exemplary retractable wheel such that weight may no longer exert any torque on an exemplary fork.

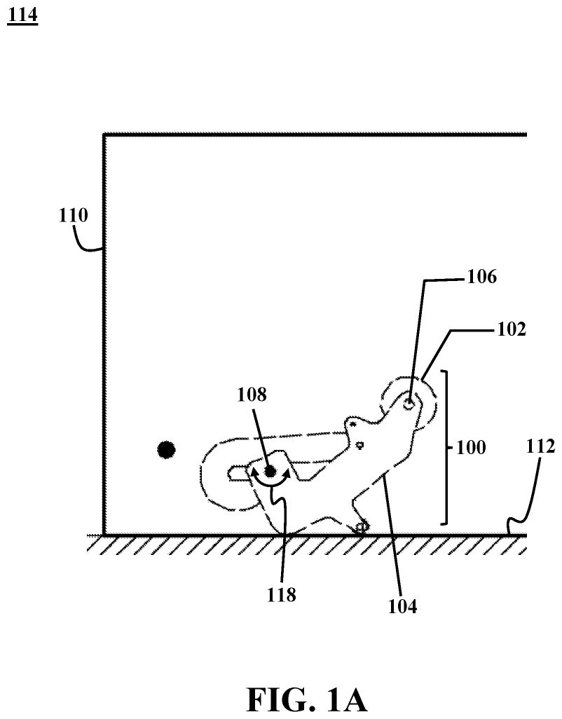

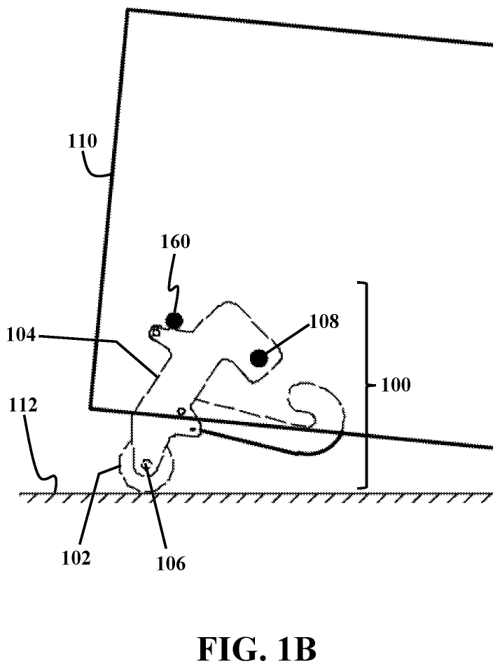

FIG. 1A illustrates a sectional side-view of a retractable wheel assembly 100 in a scenario 114 where retractable wheel assembly 100 is in a retracted position, consistent with one or more exemplary embodiments of the present disclosure. FIG. 1B illustrates a sectional side-view of retractable wheel assembly 100 in a scenario 116 where retractable wheel assembly 100 is in an extended position, consistent with one or more exemplary embodiments of the present disclosure. In an exemplary embodiment, retractable wheel assembly 100 may include a wheel 102 that may be coupled to an object 110 by utilizing a fork 104. In an exemplary embodiment, fork 104 may be attached to object 110 by utilizing a main pivot joint 108 and may further be coupled to wheel 102 by utilizing a main axle 106. In an exemplary embodiment, retractable wheel assembly 100 may pivot about main pivot joint 108 between a retracted position as illustrated in scenario 114 and an extended position 116 as illustrated un scenario 116. In an exemplary embodiment, retractable wheel assembly 100 may pivot about main pivot joint 108 between a retracted position and an extended position in directions shown by an arrow 118. In an exemplary embodiment, in scenario 114, retractable wheel assembly 100 may be tucked under object 110 out of sight and may provide a static support for object 110 over a support surface 112. In an exemplary embodiment, in scenario 116, retractable wheel assembly 100 may be extended under object 110 and may facilitate movement of object 110 over support surface 112, as will be discussed.

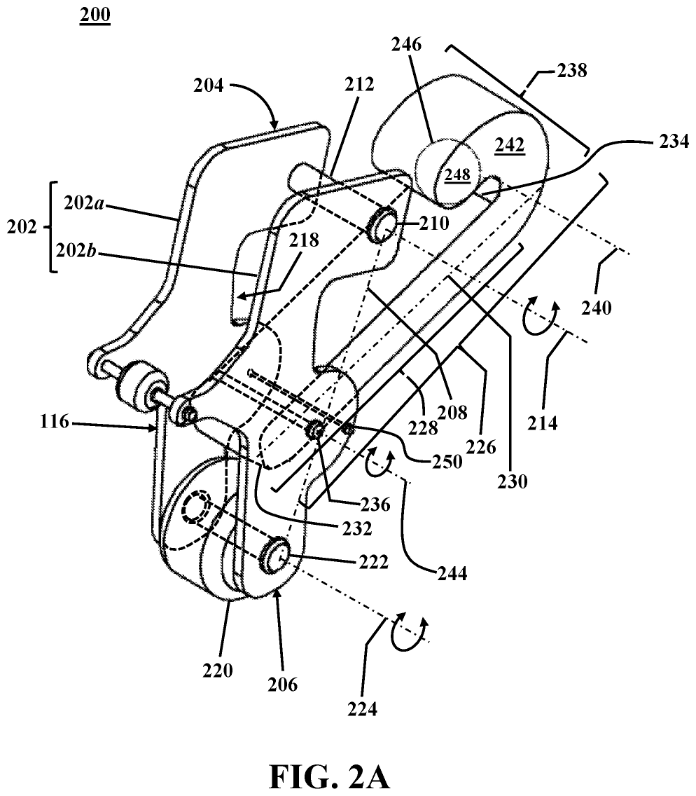

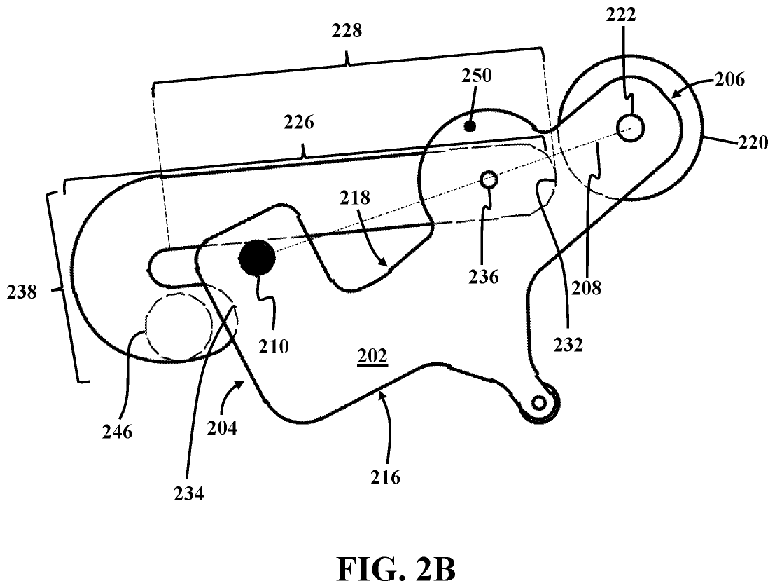

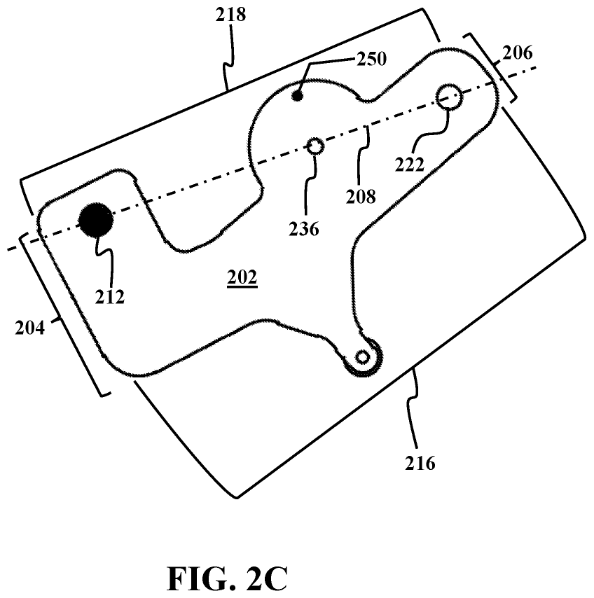

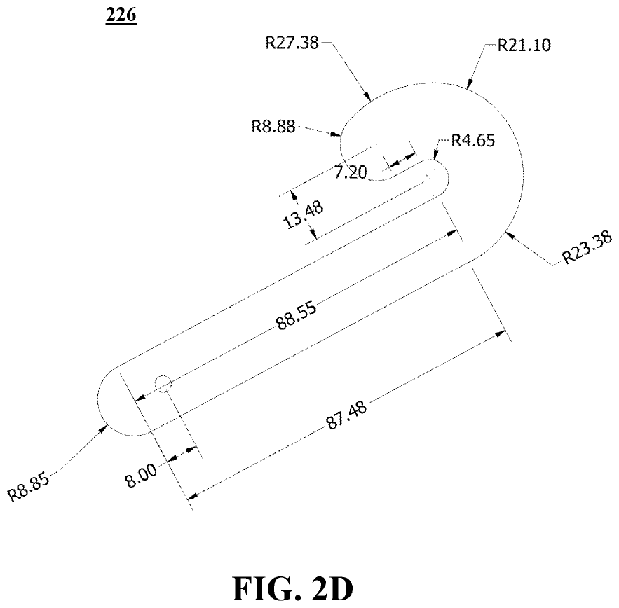

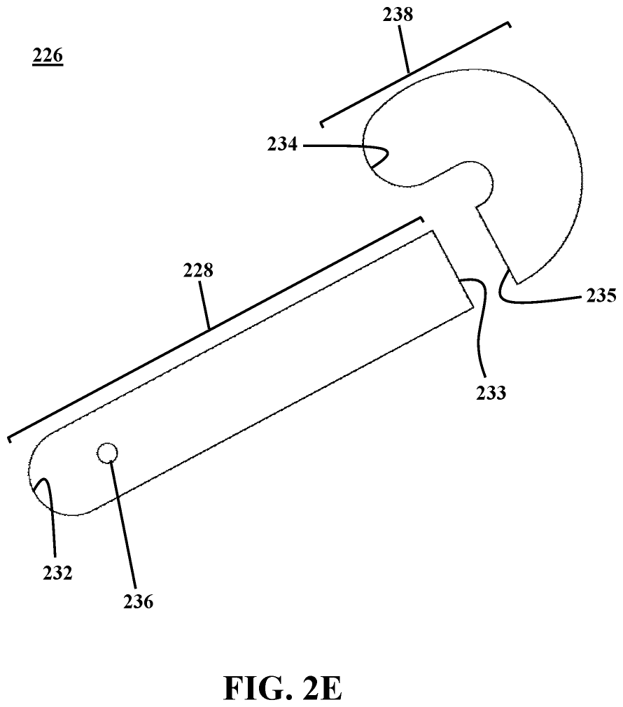

FIG. 2A illustrates a perspective view of a retractable wheel assembly 200, consistent with one or more exemplary embodiments of the present disclosure. FIG. 2B illustrates a side-view of retractable wheel assembly 200, consistent with one or more exemplary embodiments of the present disclosure. FIG. 2C illustrates a side-view of a fork 202 of retractable wheel assembly 200, consistent with one or more exemplary embodiments of the present disclosure. In an exemplary embodiment, retractable wheel assembly 200 may be structurally similar to retractable wheel assembly 100 and fork 202 may be structurally similar to fork 104.

In an exemplary embodiment, retractable wheel assembly 200 may include a fork 202 that may include two spaced-apart parallel flat plates, namely, a first plate 202a and a second plate 202b. In an exemplary embodiment, first plate 202a may be parallel with and structurally similar to second plate 202b. In an exemplary embodiment, fork 202 may further include a main pin 212 similar to the pin of main pivot joint 108. In an exemplary embodiment, main pin 212 may be connected between first plate 202a and second plate 202b, thereby interconnecting first plate 202a and second plate 202b. In an exemplary embodiment, main pin 212 may further be coupled to corresponding pin holes on an object similar to object 110, thereby forming a main pivot joint similar to main pivot joint 108. In an exemplary embodiment, fork 202 may pivot relative to an object about a main pivot axis 214. In an exemplary embodiment, main pivot axis 214 may coincide with a longitudinal axis of main pin 212. In an exemplary embodiment, fork 202 may further include a main axle 222 similar to main axle 106 that may further be connected between first plate 202a and second plate 202b. As used herein, a main axis 208 of fork 202 may refer to an axis extended between a midpoint of main pin 212 and main axle 222. For ease of reference, each plate (202a or 202b) may be a flat plate confined between a first lateral side 216, an opposite second lateral side 218, a proximal end 204, and a distal end 206. In an exemplary embodiment, main pin 212 may be positioned adjacent proximal end 204 of fork 202 and main axle 222 may be positioned adjacent distal end 206 of fork 202.

In an exemplary embodiment, retractable wheel assembly 200 may further include a wheel 220 that may be rotatably coupled to fork 202 by utilizing main axle 222. In an exemplary embodiment, wheel 220 may be rotatable about a rotational axis 224 of main axle 222. In an exemplary embodiment, wheel 220 may further be pivotable with fork 202 about main pivot axis 214. In an exemplary embodiment, rotational axis 224 may be parallel with main pivot axis 214.

FIG. 2D illustrates a side-view of a hollow housing 226 of retractable wheel assembly 200, consistent with one or more exemplary embodiments of the present disclosure. FIG. 2E illustrates an exploded side-view of hollow housing 226, consistent with one or more exemplary embodiments of the present disclosure. In an exemplary embodiment, retractable wheel assembly 200 may further include hollow housing 226 that may be curved at one end. In an exemplary embodiment, hollow housing 226 may be a hollow compartment that extends straightly from a first end 232 of hollow housing 226 forming an elongated housing portion 228 and may then curve by 180° and further extend back parallel with elongated housing portion 228 to a second end 234 of hollow housing 226. In other words, hollow housing 226 may be made by attaching or integrally forming two portions, elongated housing portion 228 and a curved housing portion 238. In an exemplary embodiment, elongated housing portion 228 may start from first end 232 of hollow housing 226 and may extend straightly to a point (labeled as 233) where hollow housing 226 may start to curve back to second end 234 of hollow housing 226. In an exemplary embodiment, curved housing portion 238 may include a portion of hollow housing 226 that may be curved by 180° about an axis parallel with main pivot axis 214 and extended along at least a portion of elongated housing portion 228 to second end 234 of hollow housing 226. In other words, curved housing portion 238 may be curved on a plane perpendicular to second pivot axis 244. In an exemplary embodiment, elongated housing portion 228 may include a hollow interior and curved housing portion 238 may include a hollow interior, where connecting or integrally forming elongated housing portion 228 and curved housing portion 238 may form a seamless hollow interior or inner volume for hollow housing 226. In an exemplary embodiment, hollow housing 226 may have a circular, rectangular, or a square cross section.

In an exemplary embodiment, elongated housing portion 228 may further include a pin joint 236 that may be utilized to pivotally couple elongated housing portion 228 to fork 202. In an exemplary embodiment, pin joint 236 may be positioned adjacent first end 232 of hollow housing 226. In an exemplary embodiment, pin joint 236 may be positioned along main axis 208 between main axle 222 and main pivot joint 210. In an exemplary embodiment, hollow housing 226 may be pivotable about a second pivot axis 244 of pin joint 236.

In an exemplary embodiment, retractable wheel assembly 200 may further include a weight 246 that may be disposed and moveable within hollow housing 226. In an exemplary embodiment, weight 246 may include a spherical weight 248. In an exemplary embodiment, an inner volume of hollow housing 22 may provide an enclosed pathway for weight 246, within which weight 246 may freely move under the force of gravity, as will be discussed.

In an exemplary embodiment, fork 202 may further include a first stop pin 250. In an exemplary embodiment, first stop pin 250 may be an elongated pin mounted between first and second plates (202a, 202b) of fork 202 along an axis parallel with main pivot axis 214. In an exemplary embodiment, first stop pin 250 may be positioned between main pivot joint 210 and main axle 222 along main axis 208 of fork 202. In an exemplary embodiment, main pin 212 and first stop pin 250 are positioned at opposite sides of elongated housing portion 228 such that pivotal movement of elongated housing portion 228 about pin joint 236 may be limited by utilizing main pin 212 and first stop pin 250, as will be discussed.

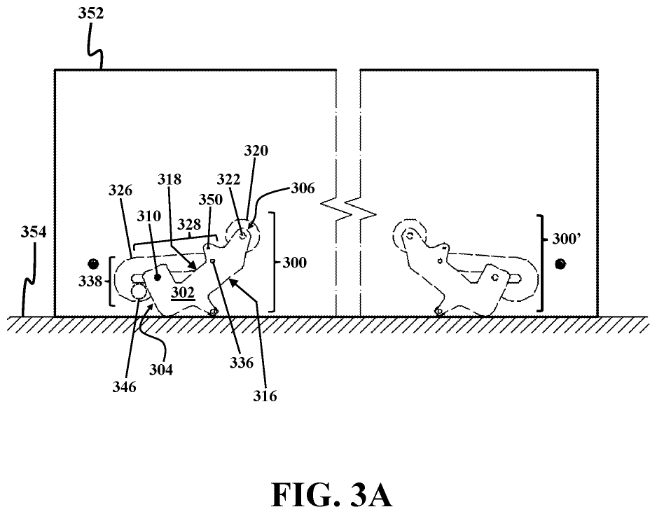

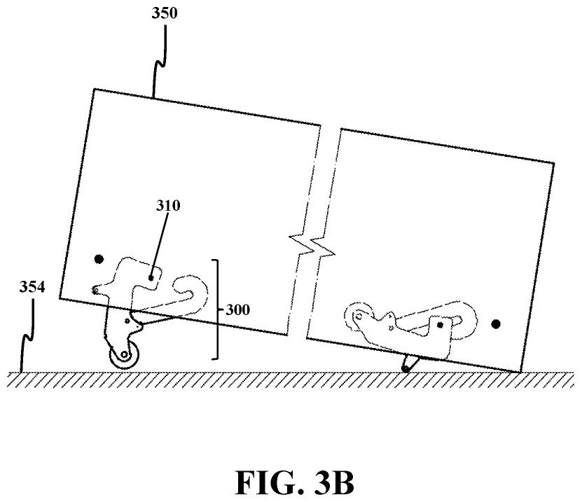

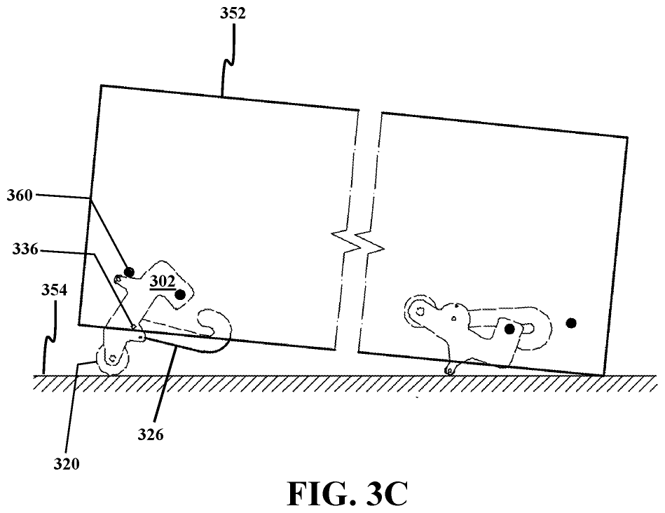

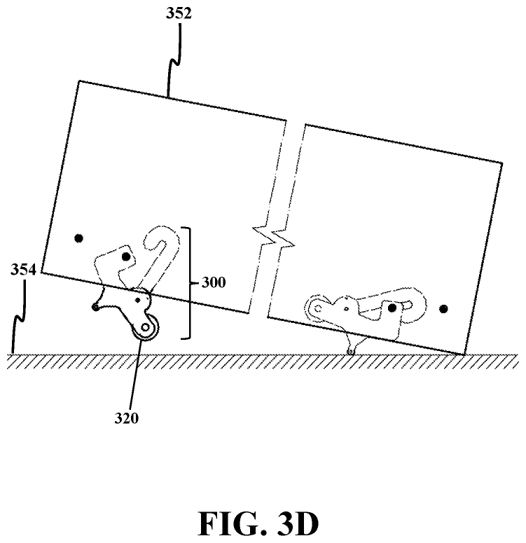

FIGS. 3A-3D illustrate stages of extending/retracting a retractable wheel assembly 300 mounted on an object 352, consistent with one or more exemplary embodiments of the present disclosure. In an exemplary embodiment, retractable wheel assemblies 100, 200, and 300 may be structurally similar. In an exemplary embodiment, object 352 may be coupled to more than one retractable wheel assemblies, such as retractable wheel assemblies (300 and 300′). In an exemplary embodiment, object 352 may include a box, carton, or container with various shapes, configurations, sizes, and materials of construction.

In an exemplary embodiment, retractable wheel assembly 300 may include a fork 302 similar to fork 202 that may be pivotally coupled to object 352 and a wheel 320 similar to wheel 220 that may be rotatably coupled to fork 302. In an exemplary embodiment, fork 302 may include a main pivot joint 310 similar to main pivot joint 210 that may be utilized to pivotally couple fork 302 to object 352. In an exemplary embodiment, fork 302 may further include a main axle 322 similar to main axle 222 that may be utilized to couple wheel 320 to fork 302. For ease of reference, fork 302 may be confined between a first lateral side 316 similar to first lateral side 216, an opposite second lateral side 318 similar to second lateral side 218, a proximal end 304 similar to proximal end 204, and a distal end 206 similar to distal end 306. In an exemplary embodiment, main pin 312 may be positioned adjacent proximal end 304 of fork 302 and main axle 322 may be positioned adjacent distal end 306 of fork 302.

In an exemplary embodiment, retractable wheel assembly 300 may further include a hollow housing 326 similar to hollow housing 226 with an elongated housing portion 328 similar to elongated housing portion 228 and a curved housing portion 338 similar to curved housing portion 238 integrally formed with elongated housing portion 328. In an exemplary embodiment, elongated housing portion 328 may be pivotally coupled to fork 302 utilizing a pin joint 336 similar to pin joint 236. In an exemplary embodiment, retractable wheel assembly 300 may further include a weight 346 similar to weight 246 that may be disposed and moveable within hollow housing 326. In an exemplary embodiment, retractable wheel assembly 300 may further include a first stop pin 350 similar to first stop pin 250 that may be mounted on fork 302. In an exemplary embodiment, main pin 312 and first stop pin 350 are positioned at opposite sides of elongated housing portion 328 such that pivotal movement of elongated housing portion 328 may be limited between main pin 312 and first stop pin 350.

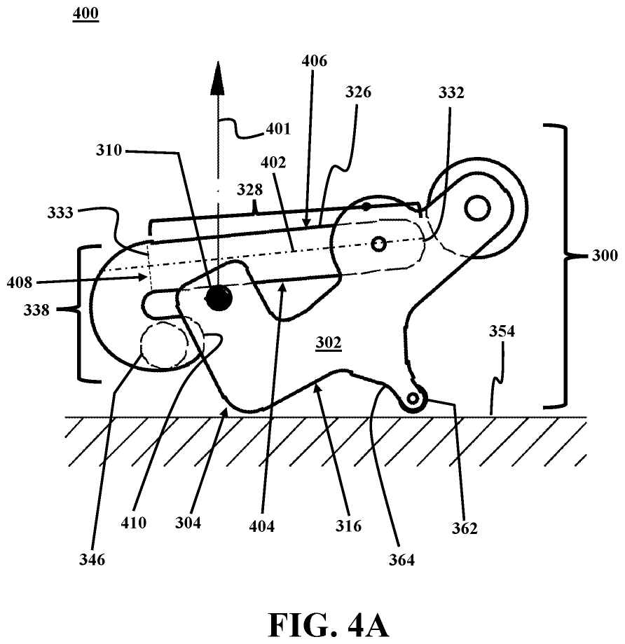

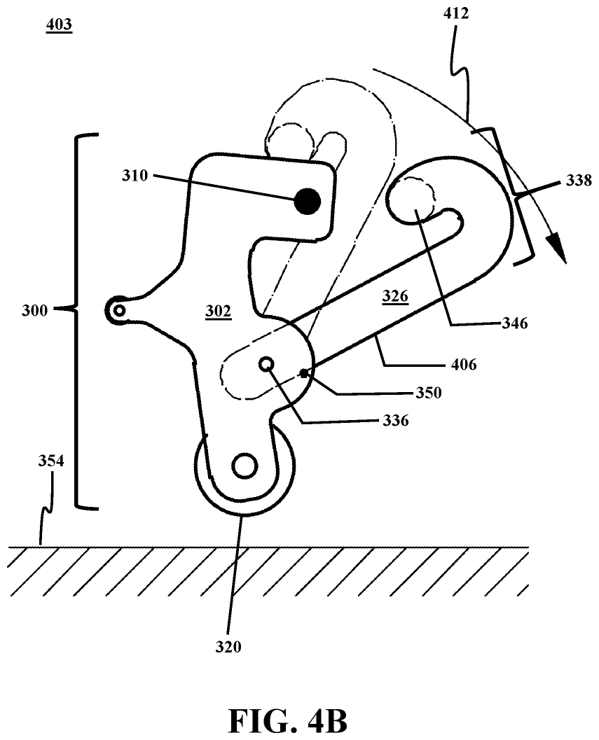

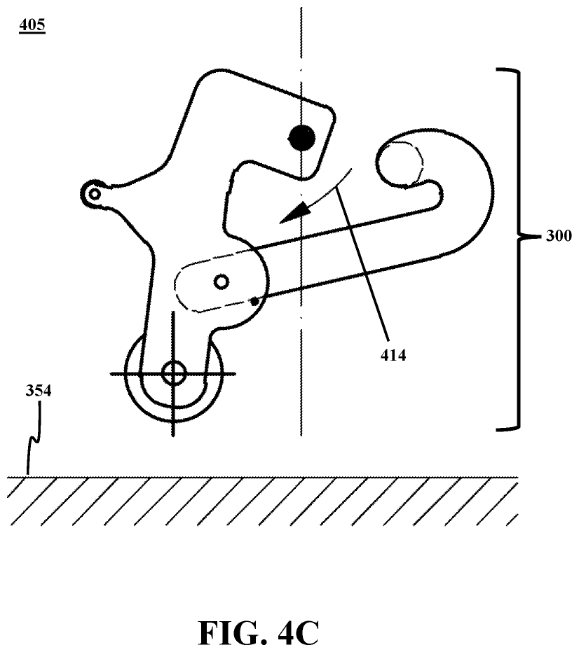

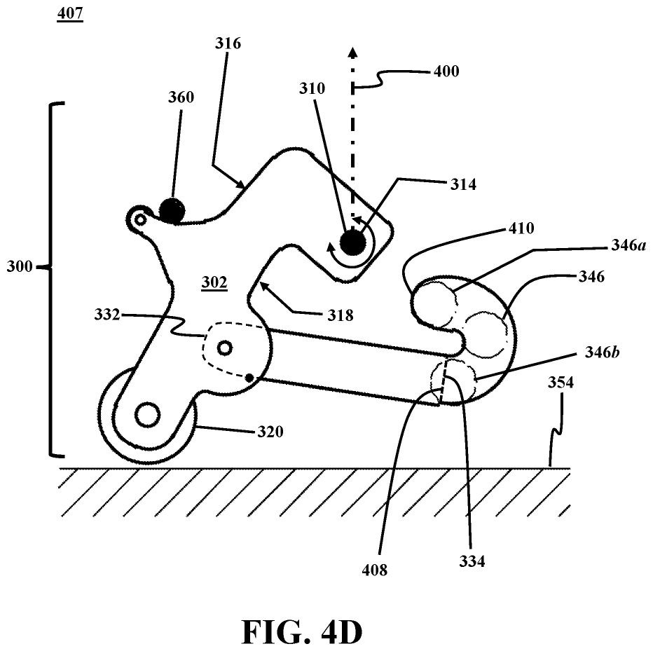

FIG. 3A illustrates retractable wheel assembly 300 in a fully retracted position, where retractable wheel assembly 300 may be tucked under object 352 over a support surface 354. FIG. 4A illustrates a first scenario 400 which encompasses a sideview of retractable wheel assembly 300 in a fully retracted position, consistent with one or more exemplary embodiments of the present disclosure.

In an exemplary embodiment, a fully retracted position for retractable wheel assembly 300 may correspond to a position, where fork 302 may face support surface 354 from first lateral side 316 and may rest upon support surface 352 from proximal end 304 of fork 302. In a fully retracted position, main pivot joint 310 may function as a stop pin for hollow housing 326, and hollow housing 326 may rest upon main pivot joint 310. In an exemplary embodiment, a longitudinal axis 402 of elongated housing portion 328 may be inclined towards support surface 354, such that a first end 332 of elongated housing portion 328 may be positioned higher than an end point 333 of elongated housing portion 328 with respect to a vertical axis 401. As used herein, vertical axis 401 is an axis, along which, gravity force is exerted on retractable wheel assembly 300. As used herein, longitudinal axis 402 may refer to an axis associated with the longest dimension of elongated housing portion 328.

In an exemplary embodiment, elongated housing portion 328 may be confined between a first side 404 and an opposing second side 406 that may both extend along longitudinal axis 402 between a first end 332 of elongated housing portion 328 and an end point 333 of elongated housing portion 328. In an exemplary embodiment, curved housing portion 338 may curve about an axis perpendicular to longitudinal axis 402 toward first side 404 of elongated housing portion 328. In an exemplary embodiment, a fully retracted position for retractable wheel assembly 300 may further correspond to a position, where first side 404 of elongated housing portion 328 may rest upon main pivot joint 310.

In an exemplary embodiment, curved housing portion 338 may be a U-shaped portion similar to curved housing portion 238 that may be curved between a first extremity 408 similar to first extremity 235 and a second extremity 410 which may coincide with second end 234 of hollow housing 226. In an exemplary embodiment, first extremity 408 of curved housing portion 338 may be integrally formed with end point 333 of elongated housing portion 328. In an exemplary embodiment, a fully retracted position for retractable wheel assembly 300 may further correspond to a position, where weight 346 may be position within second extremity 410 of curved housing portion 338. In an exemplary embodiment, such positioning of first side 404 of elongated housing portion 328 on main pivot joint 310 and such positioning of weight 346 within second extremity 410 of curved housing portion 338 may allow for the entire weight of hollow housing 326 and weight 346 to be supported by main pivot joint 310.

In an exemplary embodiment, in a fully retracted position, retractable wheel assembly 300 may be configured to allow object 352 to rest on and statically contact support surface 354. In an exemplary embodiment, first lateral side 316 of retractable wheel assembly 300 may further include a roller 362 that may be attached to first lateral side 316. In an exemplary embodiment, roller 362 may be rotatably mounted on a side arm 364 laterally extended from first lateral side 316 of retractable wheel assembly 300. In an exemplary embodiment, the fully retracted position of retractable wheel assembly 300 may further correspond to a position, where roller 362 may contact and rest upon support surface 354.

Referring to FIG. 3B, in an exemplary embodiment, when object 352 is lifted or separated from support surface 354, retractable wheel assembly 300 may pivot about main pivot joint 310 under the force of gravity and may hang freely below main pivot joint 310. FIGS. 4B and 4C illustrate second scenario 403 and third scenario 405 which encompass side-views of retractable wheel assembly 300 hanging below main pivot joint 310, consistent with one or more exemplary embodiments of the present disclosure. In an exemplary embodiment, retractable wheel assembly 300 may hang freely from and below main pivot joint 310 in response to object 352 being lifted from support surface 354, such that wheel 320 may be hanging freely above support surface 354. In an exemplary embodiment, responsive to fork 302 hanging from and below main pivot joint 310, the gravity force may urge hollow housing 326 to pivot about pin joint 336 in a direction shown by arrow 412 to the point, where second side 406 of hollow housing 326 may rest upon first stop pin 350. In an exemplary embodiment, in response to second side 406 of hollow housing 326 leaning on first stop pin 350, weight 346 within curved housing portion 338 may exert a torque on fork 302 at first stop pin 350 causing a center of mass of retractable wheel assembly 300 to be pushed away from below main pivot joint 310 in a direction shown by arrow 414.

Referring to FIG. 3C, in an exemplary embodiment, after pivotal movement of hollow housing 326 about pin joint 336 under the force of gravity and exertion of the torque by weight 346 on fork 302, when object 352 is put down on support surface 354, wheel 306 may roll on support surface 354 towards a fully extended position of retractable wheel assembly 300.

FIG. 4D illustrates a fourth scenario 407 which encompasses a side-view of retractable wheel assembly 300 in a fully opened or extended position over support surface 354, consistent with one or more exemplary embodiments of the present disclosure. In an exemplary embodiment, a fully extended position of retractable wheel assembly 300 may correspond to a position, where second lateral side 318 of fork 302 may face support surface 354 and wheel 320 may contact support surface 354. In an exemplary embodiment, a second stop pin 360 may be mounted on object 352 that may extend parallel with a main pivot axis 314. In an exemplary embodiment, main pivot axis 314 of main pivot joint 310 is perpendicular to the view in FIG. 4B. In an exemplary embodiment, second stop pin 360 may be configured to limit pivotal movement of fork 302 about main pivot joint 310. In other words, first lateral side 316 of fork 302 may rest upon second stop pin 360 and thereby preventing further pivotal movement of fork 302 about main pivot joint 310.

In an exemplary embodiment, the fully extended position of retractable wheel assembly 300 may further correspond to a position, where end point 333 of elongated housing portion 328 may be positioned lower than first end 332 of elongated housing portion 328 with respect to vertical axis 401. In an exemplary embodiment, the fully extended position of retractable wheel assembly 300 may further correspond to a position, where weight 346 may move from second extremity 410 of curved housing portion 338 to first extremity 408 of curved housing portion 338 in response to hollow housing 326 pivoting about pin joint 336 to the point where second side 406 of hollow housing 326 contacts first stop pin 350. Referring to FIG. 4D, weight 346 in second extremity 410 of curved housing portion 338 is designated by reference numeral 346a and weight 346 in first extremity 408 of curved housing portion 338 is designated by reference numeral 346b.

Referring to FIG. 3D, in an exemplary embodiment, in order to retract or close retractable wheel assembly 300 when wheel 320 is no longer required for facilitating the movement of object 352 over support surface 354, object 352 may need to be lifted or separated from support surface 354 one more time. In other words, to retract retractable wheel assembly 300, object 352 may be lifted from support surface 354.

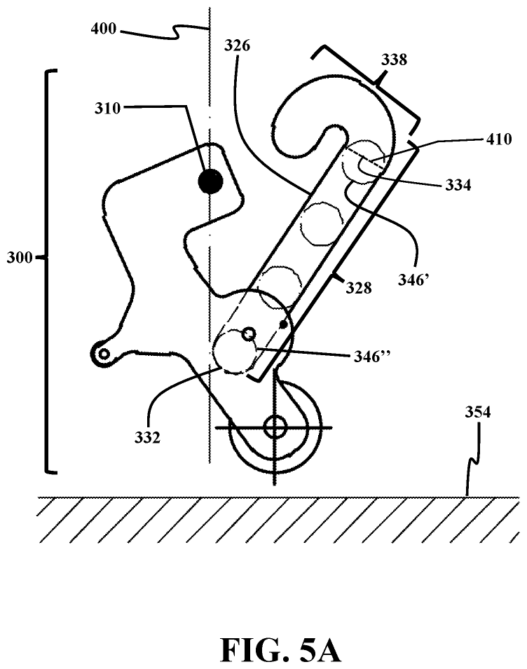

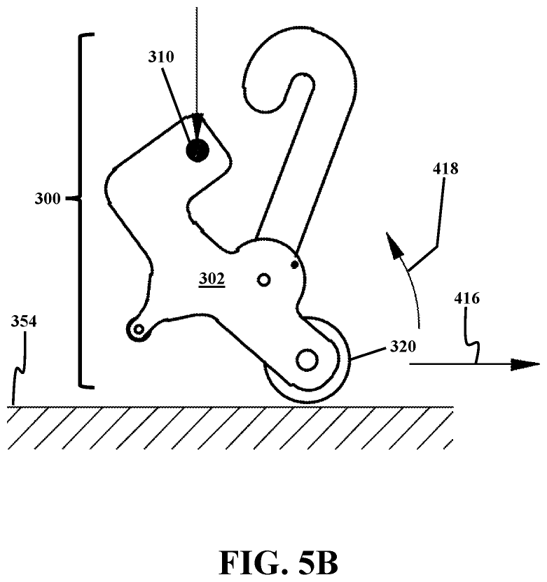

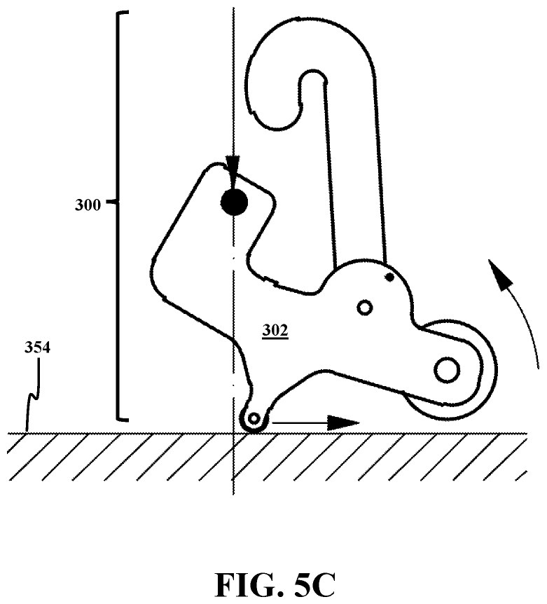

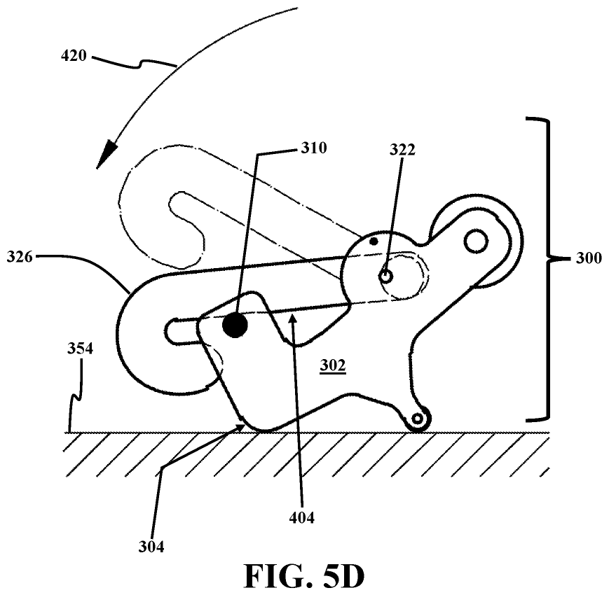

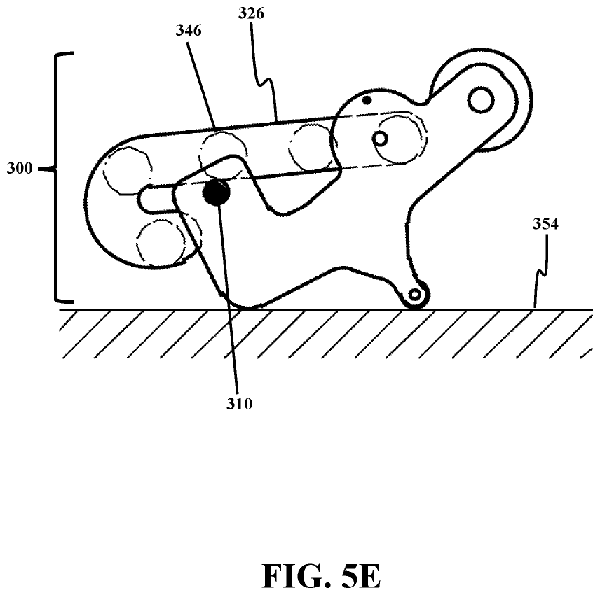

FIG. 5A illustrates a sideview of retractable wheel assembly 300 hanging below and from main pivot joint 310, consistent with one or more exemplary embodiments of the present disclosure. In an exemplary embodiment, in the fully extended position of retractable wheel assembly 300, weight 346 was positioned in second extremity 410 of curved housing portion 338 which coincides with end point 333 of elongated housing portion 328. In response to object 352 being lifted from support surface 354, as retractable wheel assembly 300 freely pivots about main pivot joint 310, hollow housing 326 may also pivot about main pivot joint 310 along with fork 302. In an exemplary embodiment, such pivotal movement of hollow housing 326 may lead to end point 333 of elongated housing portion 328 being positioned higher than first end 332 of elongated housing portion 328 with respect to vertical axis 401. Consequently, the gravity force may urge weight 346 to move along elongated housing portion 328 from end point 333 to first end 332 of elongated housing portion 328. Referring to FIG. 5A, weight 346 is referred to by reference numeral 346′ in end point 333 and by reference numeral 346″ in first end 332. In an exemplary embodiment, when weight 346″ is positioned within first end 332 of elongated housing portion 328 no torque may be exerted by weight 346″ on fork 302.

FIGS. 5B-5E illustrate various stages of retractable wheel assembly 300 being retracted, consistent with one or more exemplary embodiments of the present disclosure. In an exemplary embodiment, when object 352 is placed back on support surface 354, wheel 320 may contact support surface 354 and may roll on support surface 354 in a direction shown by arrow 416 and then putting object 352 down may urge retractable wheel assembly 300 to pivot about main pivot joint 310 in a direction shown by arrow 418. Further lowering of object 352 may lead to roller to come into contact with support surface 354 and roll over support surface 354 to further guide fork 302 to pivot about main pivot joint 310 to the point where proximal end 304 of fork 302 may also contact support surface 354. In response to fork 302 moving back to its fully retracted position as shown in FIG. 5D, hollow housing 326 may pivot about pin joint 336 in a direction shown by arrow 420 to the point where first side 404 of hollow housing 326 may rest upon main pivot joint 310.

Referring to FIG. 5E, in an exemplary embodiment, responsive to hollow housing 326 resting upon main pivot joint 310, weight 346 may move within elongated housing portion 328 towards curved housing portion 338 and finally weight 346 may be positioned at second extremity 410 of curved housing portion 338 one more time. Here, weight 346 at various positions during movement is illustrated by broken lines. At this stage, retractable wheel assembly 300 is in a fully retracted position again and ready to be deployed or extended whenever object 352 is lifted from support surface 354 again.

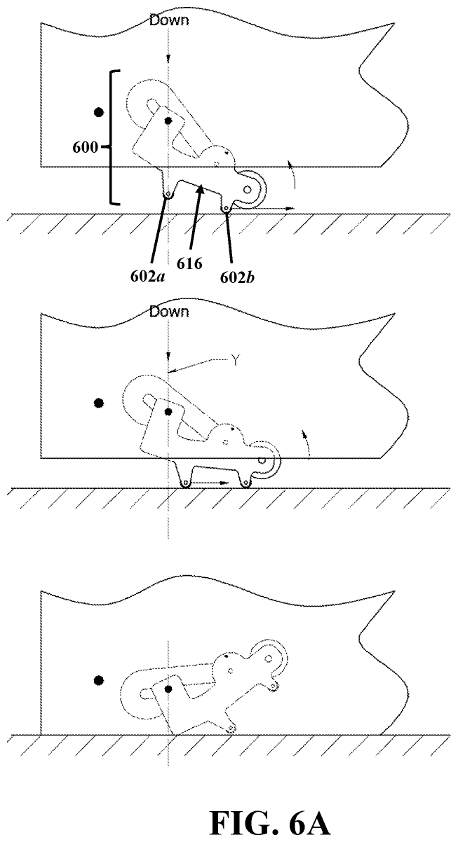

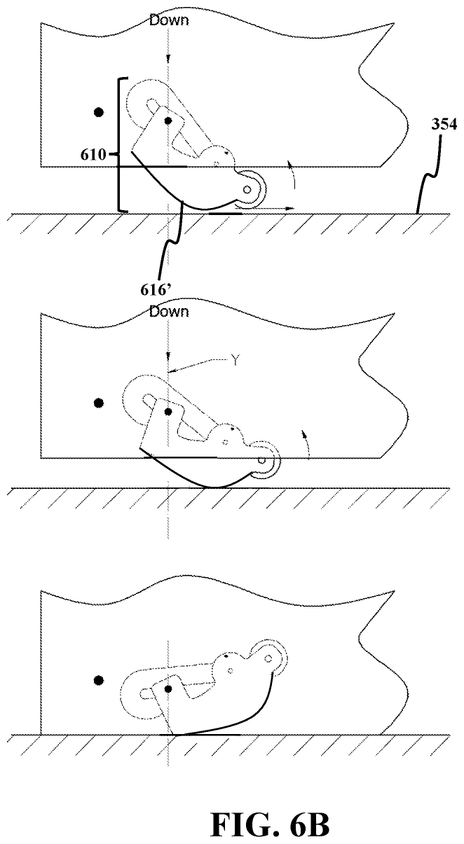

FIG. 6A illustrates different stages of retracting a retractable wheel assembly 600, consistent with one or more exemplary embodiments of the present disclosure. FIG. 6B illustrates different stages of retracting a retractable wheel assembly 610, consistent with one or more exemplary embodiments of the present disclosure. In an exemplary embodiment, retractable wheel assembly 600 may include two rollers (602a, 602b) mounted on a first lateral side 616 of retractable wheel assembly 600. In an exemplary embodiment, each roller of two rollers (602a, 602b) may be structurally similar to roller 362 and may function similar to roller 362 as was discussed in previous paragraphs.

In an exemplary embodiment, retractable wheel assembly 610 may include a first lateral side 616′ similar to first lateral side 316. In an exemplary embodiment, first lateral side 616′ may be curved convexly with respect to support surface 354. In an exemplary embodiment, first lateral side 616′ may function similar to roller 362.

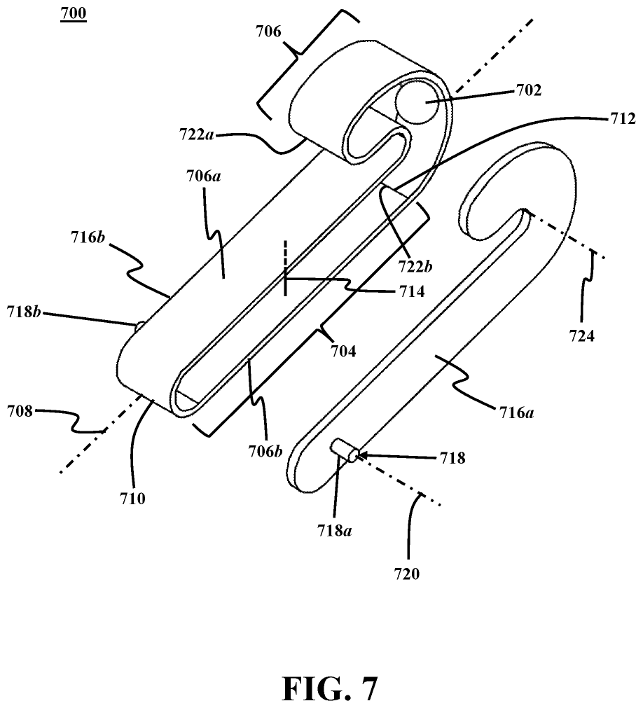

FIG. 7 illustrates an exploded perspective view of a hollow housing 700, consistent with one or more exemplary embodiments of the present disclosure. In an exemplary embodiment, hollow housing 700 may be structurally similar to hollow housings (226, 326) and may be configured to house a weight 702 within hollow housing 700. In an exemplary embodiment, weight 702 may be similar to weights (246, 346). In an exemplary embodiment, hollow housing 700 may include an elongated housing portion 704 similar to elongated housing portions (228 and 328) and a curved housing portion 706 similar to curved housing portions (238 and 338). In an exemplary embodiment, elongated housing portion 704 may be integrally formed with curved housing portion 706. In an exemplary embodiment, hollow housing 700 may be a hollow enclosure that may be configured to allow for weight 702 to be disposed and freely moveable within hollow housing 700. In an exemplary embodiment, weight 702 may be configured as a spherical weight that may freely move within the hollow enclosure provided by hollow housing 700.

In an exemplary embodiment, elongated housing portion 704 may include an elongated top wall 706a and an opposing elongated bottom wall 706b that may extend along a longitudinal axis 708 of elongated housing portion 704 between a proximal end 710 of elongated housing portion 704 and an opposing distal end 712 of elongated housing portion 704. In an exemplary embodiment, elongated top wall 706a and elongated bottom wall 706b may be parallel with each other and may be spaced apart along an axis 714 perpendicular to longitudinal axis 708 of elongated housing portion 704. In an exemplary embodiment, hollow housing 700 may further be confined between a first lateral wall 716a and an opposing second lateral wall 716b. As used herein, longitudinal axis 708 of elongated housing portion 704 may refer to an axis associated with the longest dimension of elongated housing portion 704.

In an exemplary embodiment, hollow housing 700 may further include a pin 718 that may be mounted on either lateral wall (716a, 716b) adjacent proximal end 710 of elongated housing portion 704. In an exemplary embodiment, pin 718 may include two separate portions (718a, 718b), where each portion of separate portions (718a, 718b) may be mounted on each respective lateral wall of lateral walls (716a, 716b) of hollow housing 700. In an exemplary embodiment, pin 718 together with a corresponding pin hole on an exemplary fork of an exemplary retractable wheel assembly may form an exemplary pin joint similar to pin joints (236, 336). In an exemplary embodiment, hollow housing 700 may be configured to be freely pivotable about such exemplary pin joint that may be formed utilizing pin 718. In an exemplary embodiment, pin 718 may be extended along a pivot axis 720 similar to rotational axis 224 that may be mutually perpendicular to longitudinal axis 708 of elongated housing portion 704 and each of lateral walls (718a, 718b). In an exemplary embodiment, elongated top wall 706a and elongated bottom wall 706b may be parallel with both longitudinal axis 708 and pivot axis 720. In an exemplary embodiment, hollow housing 700 may be configured to be freely pivotable about pivot axis 720 under the force of gravity.

In an exemplary embodiment, curved housing portion 706 may be a U-shaped portion that may be curved between a first extremity 722a and a second extremity 722b. In an exemplary embodiment, second extremity 722b of curved housing portion 706 may be integrally formed with second end 712 of elongated housing portion 704. In an exemplary embodiment, curved housing portion 706 may be curved around an axis 724 perpendicular to longitudinal axis 708 of elongated housing portion 704. In other words, curved housing portion 706 may be curved on a plane perpendicular to pivot axis 720 and parallel with longitudinal axis 708. In an exemplary embodiment, elongated housing portion 704 and curved housing portion 706 may provide a candy cane-shaped enclosure for weight 702 to freely roll within under the force of gravity.

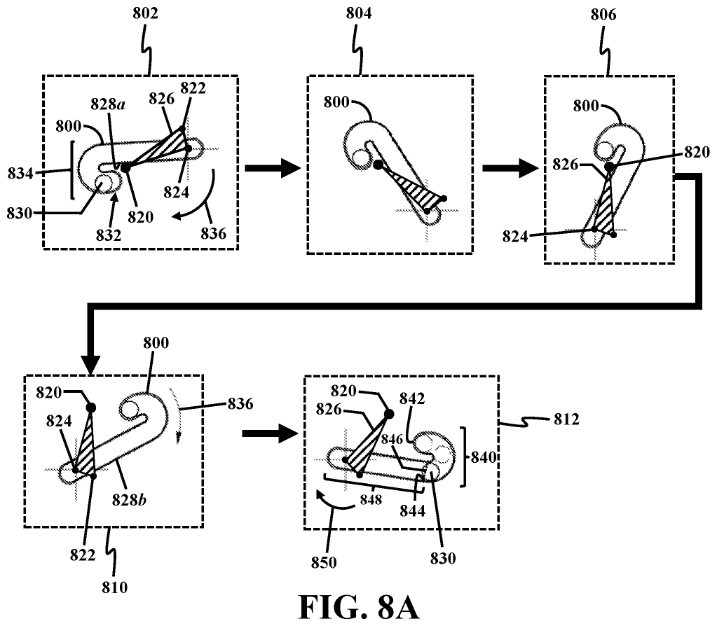

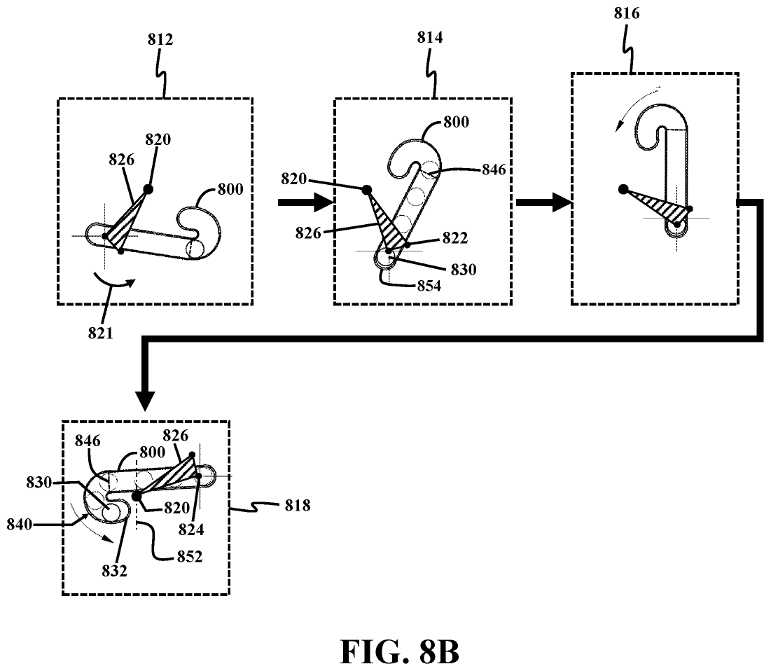

FIG. 8A illustrates a housing 800 in various stages (802, 804, 806, 808, and 810) of extending a retractable wheel assembly, consistent with one or more exemplary embodiments of the present disclosure. FIG. 8B illustrates housing 800 in various stages (812, 814, 816, and 818) of retracting a retractable wheel assembly, consistent with one or more exemplary embodiments of the present disclosure. In an exemplary embodiment, housing 800 may be structurally similar to hollow housings (226, 326, and 700). In an exemplary embodiment, a weight 830 similar to weight 702 may be disposed within hollow housing 800.

Referring to FIG. 8A, a main pivot joint 820 of an exemplary retractable wheel assembly similar to main pivot joint 310, a first stop pin 822 similar to first stop pin 350, and a main axle 824 similar to main axle 322 are illustrated. In an exemplary embodiment, main pivot joint 820, first stop pin 822, and main axle 824 may be interconnected by utilizing an exemplary fork similar to fork 302. For simplicity, an exemplary fork, on which main pivot joint 820, first stop pin 822, and main axle 824 may be mounted is represented by a triangular fork 826 interconnecting main pivot joint 820, first stop pin 822, and main axle 824.

In an exemplary embodiment, stage 802 may correspond to a fully retracted position of an exemplary retractable wheel assembly, where an elongated top wall 828a of hollow housing 800 may rest upon main pivot joint 820 and weight 830 may be located within a first extremity 832 of a curved housing portion 834 of hollow housing 800. In an exemplary embodiment, when an exemplary object to which an exemplary retractable wheel assembly is mounted, is lifted up from the ground, fork 826 may freely pivot about main pivot joint 820 in a direction shown by arrow 836. Such pivotal motion of fork 826 about main pivot axis 820 in the direction of arrow 836 is illustrated in stages 804 and 806. In an exemplary embodiment, responsive to fork 826 dangling below main pivot joint 820 as illustrated in stage 806, the force of gravity may urge hollow housing 800 to pivot freely about main axle 824 in a direction show by arrow 838 in stage 810. Then, hollow housing 800 may pivot to the point, where an elongated bottom wall 828b of hollow housing 800 may rest upon first stop pin 822. In an exemplary embodiment, as hollow housing 800 freely pivots or in other words freely falls onto first stop pin 822, given the positioning of weight 830, hollow housing 800 may exert torque onto fork 826 to further urge fork 826 to pivot about main pivot joint 820 in a direction shown by arrow 850.

Referring to stage 812, in an exemplary embodiment, responsive to hollow housing 800 freely falling onto first stop pin 822, weight 830 may freely move from a first extremity 842 of a curved housing portion 840 of hollow housing 800 to a second extremity 844 of curved housing portion 840, where second extremity 844 of curved housing portion 840 coincides with a distal end 846 of an elongated housing portion 848 of hollow housing 800. In practice, when an exemplary retractable wheel assembly is extended under an exemplary object, an exemplary housing of an exemplary retractable wheel assembly, such as hollow housing 800 may remain in the configuration shown in stage 812, specifically, weight 830 may remain within distal end 846 of elongated housing portion 848.

In an exemplary embodiment, such configuration of main pivot joint 820 and first stop pin 822 may allow for limiting the free pivotal movement of hollow housing 800 about main axle 824. In an exemplary embodiment, pivotal movement of hollow housing 800 may be limited between main pivot joint 820 and first stop pin 822.

When a user is done with moving an exemplary object equipped with an exemplary retractable wheel assembly, they may lift up an exemplary object from the ground and then place it on the ground again. This way, an exemplary retractable wheel assembly may be retracted under an exemplary object. Referring to FIG. 8B, hollow housing 800 is illustrated at different stages (812, 814, 816, and 818) of retracting an exemplary retractable wheel assembly.

In an exemplary embodiment, when an exemplary object is lifted from the ground, fork 826 may freely pivot about main pivot joint 820 in a direction shown by arrow 821, as illustrated in stages 812 and 814. In an exemplary embodiment, as fork 826 hangs freely below main pivot joint 820, hollow housing 800 may be urged by first stop pin 822 to rotate into an approximately upright position as shown in stage 814. In an exemplary embodiment, responsive to hollow housing 800 being in an upright position, weight 830 may fall from distal end 846 of elongated housing portion 848 to a proximal end 854 of elongated housing portion 848 as illustrates by broken circles in stage 814. Then by placing an exemplary object down onto the ground, fork 826 may further be pushed to pivot about main pivot joint 820 and in response, hollow housing 800 may freely pivot about main axle 824 under the force of gravity. As an exemplary retractable wheel assembly is completely tucked under an exemplary object, top wall of hollow housing 800 may rest upon main pivot joint 820 one more time and due to main pivot joint 820 being lower than main axle 824 with respect to a vertical axis 852, weight 830 may roll freely from proximal end 854 of elongated housing portion 848 to distal end 846 of elongated housing portion 848 and from there weight 830 may further roll into first extremity 832 of curved housing portion 840. In other words, in response to an exemplary retractable wheel assembly returning to a fully retracted position of an exemplary retractable wheel assembly, hollow housing 800 and weight 830 may restore their respective initial positions. In practice, as long as an exemplary retractable wheel assembly is in its fully retracted position, hollow housing 800 and weight 830 may maintain their configuration in stage 818.

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for description and not of limitation, such that the terminology or phraseology of the present specification is to be interpreted by the skilled artisan in light of the teachings and guidance.

The breadth and scope of the present disclosure should not be limited by any of the above-described exemplary embodiments but should be defined only in accordance with the following claims and their equivalents.

Throughout this specification and the claims which follow, unless the context requires otherwise, the word “comprise”, and variations such as “comprises” or “comprising”, will be understood to imply the inclusion of a stated integer or step or group of integers or steps but not to the exclusion of any other integer or step or group of integers or steps. Moreover, the word “substantially” when used with an adjective or adverb is intended to enhance the scope of the particular characteristic, e.g., substantially planar is intended to mean planar, nearly planar and/or exhibiting characteristics associated with a planar element. Further use of relative terms such as “vertical”, “horizontal”, “up”, “down”, and “side-to-side” are used in a relative sense to the normal orientation of the apparatus.

What is claimed is:

1. A retractable wheel assembly, the retractable wheel assembly comprising:
a fork comprising:
two spaced-apart parallel flat plates;
a main pivot joint mounted between the two spaced-apart parallel flat plates on a first end of the fork, the main pivot joint configured to allow the fork to pivot about a main pivot axis of the main pivot joint; and
a main axle mounted between the two spaced-apart parallel flat plates on an opposite second end of the fork, wherein a longitudinal axis of the fork comprises an axis passing through the main pivot joint and the main axle;
a wheel rotatably coupled with the second end of the fork by utilizing the main axle, the wheel rotatable about a first pivot axis of the main axle, the wheel further pivotable with the fork about the main pivot joint, the first pivot axis parallel with the main pivot axis;
a housing comprising:
an elongated housing portion, a first end of the elongated housing portion pivotally coupled to the fork utilizing a pin joint, the pin joint positioned between the main axle and the main pivot joint along the longitudinal axis of the fork; and
a curved housing portion integrally formed with an opposing second end of the elongated housing portion, the curved housing portion curved about an axis parallel with the main pivot axis, the housing pivotable about a second pivot axis of the pin joint, the second pivot axis parallel with the first pivot axis; and
a weight disposed and moveable within the housing.

2. The assembly of claim 1, wherein the main pivot joint comprises a main pin extended along the main pivot axis, the main pin protruded from the fork.

3. The assembly of claim 2, further comprising a stop pin mounted on the fork, the stop pin extended along an axis parallel with the main pivot axis, the stop pin positioned between the main pivot joint and the main axle along the longitudinal axis of the fork.

4. The assembly of claim 3, wherein the main pin and the stop pin are positioned at opposite sides of the elongated housing portion along an axis perpendicular to a longitudinal axis of the elongated housing portion.

5. The assembly of claim 4, wherein the curved housing portion is curved on a plane perpendicular to the second pivot axis, the curved housing portion curved towards the first end of the elongated housing portion.

6. The assembly of claim 5, wherein the weight comprises a spherical weight.

7. The assembly of claim 6, wherein the fork is pivotally coupled to an object placed over a support surface, the fork coupled to the object utilizing the main pivot joint, the fork freely pivoting about the main pivot joint by gravity.

8. The assembly of claim 7, wherein the fork is configured to be pivotable between a retracted position and an extended position, the wheel contacts the support surface responsive to the fork being in the extended position.

9. The assembly of claim 8, wherein the retracted position corresponds to a position, wherein:
the fork rests on the support surface from a first side of the fork;
the housing rests upon the main pin, the housing positioned on a second opposing side of the fork; and
the weight positioned within the curved housing portion, and
wherein, the first side of the fork faces the support surface, and the opposite second side of the fork faces away from the support surface.

10. The assembly of claim 9, wherein the first side of the fork rests on the support surface in the retracted position, the first side of the fork comprising an outwardly curved surface.

11. The assembly of claim 9, further comprising a roller rotatably coupled to the first side of the fork, the fork configured to rest on the roller in the retracted position.

12. The assembly of claim 9, wherein the extended position corresponds to a position, wherein:
the wheel is rotatably positioned on the support surface;
the housing rests on the stop pin; and
the weight positioned within the curved housing portion at a junction between the distal end of the elongated housing portion and the curved housing portion.

13. The assembly of claim 12, wherein an axis perpendicular to the largest surface of the fork is parallel with the main pivot axis, the first pivot axis, and the second pivot axis.
